(19) United States
(12) Patent Application Publication
(10) Pub. No.: US 2008/0126307 A1
(43) Pub. Date: May 29, 2008

(54) Method for recognizing feature of 3D solid model

(76) Inventors: Bor-Tsuen Lin, Yangmei Township (TW); David Huang, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/605,419

(22) Filed: Nov. 29, 2006

(51) Int. Cl. G06F 17/30; G06F 7/00

(52) U.S. Cl. 707/3; 707/102; 707/E17.014; 707/E17.001

(57) ABSTRACT

The present invention discloses a method for recognizing features of a 3D solid model which particularly performs geometric form features. First, the main and minor geometric features of the solid model are respectively defined and sorted into classes and subclasses according to hierarchical taxonomies, and a database of structural features of the solid model is built with respect to a designed table schema. Then feature names and information are retrieved from the structural feature tree of the solid model on the basis of CSG (constructive solid geometry) by means of the “retrieving feature tree information” technique, and decomposed into geometric data and topological data which are finally stored into the database. The method of the present invention can therefore rapidly recognize the features of the solid model with high accuracy.

### BACKGROUND OF THE INVENTION

1. Field of the Invention

The present invention relates to a method for recognizing features of a 3D solid model, which particularly utilizes geometric data and topological data decomposed from a feature tree to achieve the recognition without graph-based recognition, and hierarchical taxonomies to build a relational database. Therefore, the method of the present invention can rapidly recognize features of the 3D solid model with high accuracy.

2. Related Prior Art

The term “feature” is usually defined according to applications thereof. For example, a feature can be a form primitive regarding certain a function in view of design, a shape or technological property in view of manufacturing, or a set of description or information regarding a product, components and subcomponents thereof in view of an integral platform of computer-aided design/computer-aided manufacture/computer-aided engineering/computer-aided process planning (CAD/CAM/CAE/CAPP). Therefore, “functional features” such as a rib and a U-slot in a mechanical structure are defined in view of design; “form features” such as a hole and a shell in a processing treatment are defined in view of manufacturing; and “component features” such as geometric data and topological data are defined in view of integral CAD/CAM/CAE/CAPP. Geometric data represent the volume, surface, curve and end point for the polyhedron, while topological data represent the relationship between volume, surface, curve and end point of the polyhedron.

According to the above,

1. a feature indicates geometrical description of a component;
2. a feature has a specific meaning in engineering;
3. the type and meaning of a feature are different for different processes;
4. features can be identified and transformed; and
5. the features corresponding to various applications should be defined and satisfy all requirements of the respective applications.

The feature recognition is preceded by searching and matching features according to the data of the solid model. The conventional feature recognitions are applied for 2D or 2.5D mechanical processing and process design of CAPP. In mechanical processing, the feature recognition includes convex shell, unit decomposition and geometric inference method. These approaches are operated based on volumes and surfaces, and applied to constructive solid, geometry (CSG) solid models and boundary representation (B-Rep) solid models. These approaches also utilize matching, object extrusion and volume decomposition to recognize feature of CSG. In process design of CAPP, the feature recognition includes B-Rep, CSG and the combination method, wherein B-Rep is further classified into boundary representation and graph-based approach, and CSG is classified into CSG, cell decomposition and hint-based method. The cell decomposition is further classified into volume decomposition, backward growing approach and spatial occupancy enumeration. Next, B-Rep, CSG and the combination method are described in more detail.

In “B-Rep” method, features of a component are defined as a set of faces connected to each other, and thus geometrical and topological information thereof are created within faces, edges, and end points. A definite solid model is represented by the wire-frame of faces boundaries. To recognize the faces existing in the B-Rep, required faces are added to form a closed solid model.

For “CSG” method, Boolean operations of cell decomposition, volume decomposition, backward growing and spatial occupancy enumeration approaches are used more frequently for feature recognition.

To overcome ambiguity of B-Rep and CSG, the “combination method” uses two or more types of data structures to implement demerits thereof and satisfy different applications.

For the traditional 2D or 2.5D CAD system, only geometric information of the product or components are shown. However, for the advanced 3D CAD system, not only geometric information but also the advanced information such as functions, processing, materials of the product or components are included.

In the advanced 3D CAD system, “Feature-based Design” can resolve differences between design features and manufacturing features and show the information. Recently, the feature-based design system can utilize parameterized features to describe geometric forms and functional relationships therebetween. In this system, a feature tree of a 3D solid model is provided to create the components by means of Boolean operation.

For the feature-based solid modeling technique, the 3D geometric data and data about modeling process, design function and product information may be recorded. A solid model can be established by a set of geometric primitives with certain topological relationships. Therefore, the feature-based solid modeling technique provides a main solution for information exchange between CAD/CAM/CAE/CAPP and is significantly developed.

For the traditional CSG, a complex object is decomposed into plural basic geometry solids (for example, cubes and spheres) in the form of a tree. Through Boolean operation, the basic solids can be assembled as a solid model. Therefore, the feature recognition of the traditional constructive solid geometry-based methods, called TCSG method, includes position transformations and Boolean operators for the geometrical primitives.

To explain the TCSG method, an example is illustrated with the anti-projection method.

First, a 3D object is classified into seven feature primitives including cuboid, wedge, fillet, cylinder, tetrahedron, arch, and sector. Then a 2D projection drawing of the feature primitives is analyzed as a loop assembly using the anti-projection method. By suitable judgments the loop assembly, the 2D projection drawing of the feature primitives may represent the 3D feature primitives, as shown in FIG. 1.

If the 2D projection drawing of feature part is not closed, a virtual line is added to achieve a closed loop, as shown in FIG. 2.

In case of overlapping of the primitives or parts, “volume enclosure relations” and relationships between overlapping faces of the primitive and the base part are considered to remove the useless portion, so that the recognition result can be represented as a CSG tree. Then, the data are transformed into DSG (Destructive Solid Geometry) structure for sequential applications. FIG. 3 shows volume enclosure relations and FIG. 4 shows overlapping faces of cuboids.

According to the above, the graph-based feature recognition leads many problems including closed loop, uniqueness, overlapping face, volume enclosure, interactive features and fillet. Therefore, it's desired to develop a novel technology to improve these demerits.

### SUMMARY OF THE INVENTION

The object of the present invention is to improve the TCSG method which utilizes graph-based feature recognition.

In the present invention, a feature tree is decomposed to generate geometric data and topological data used for recognition, and hierarchical taxonomies is applied to building a relational database, so that features of a 3D solid model can be quickly recognized with high accuracy.

In the present invention, the main and minor geometric shapes of the solid model are respectively defined and sorted into classes and sub-classes according to hierarchical taxonomies, and a database of structural features of the solid model is built with respect to a designed table schema. Then feature names and information are retrieved from the feature tree of the solid model on the basis of CSG by means of the “retrieving feature tree information” technique, and decomposed into geometric data and topological data which are finally stored into the database. Therefore, the method of the present invention can easily and rapidly recognize the features of the solid model according to the information in the CSG solid model with high accuracy.

### BRIEF DESCRIPTION OF THE DRAWINGS

FIG. 1 shows various feature primitives;

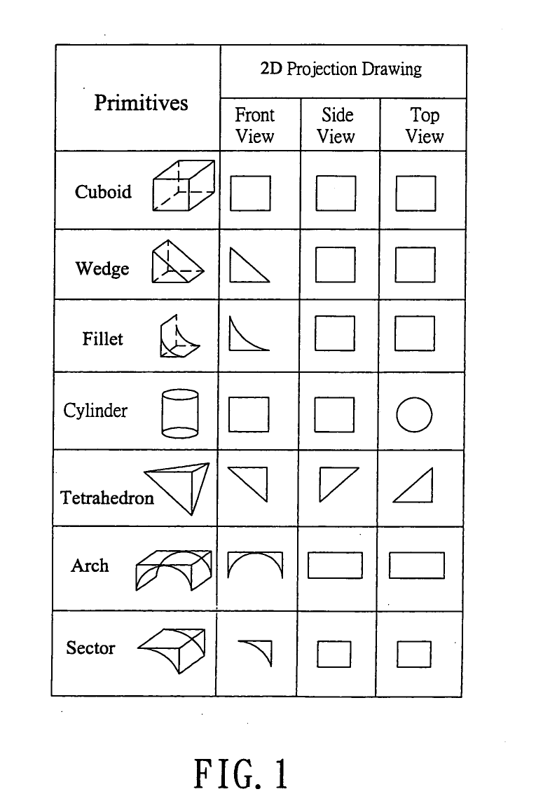

FIG. 2 shows a projection drawing with open loop transformed into a closed loop by virtual lines;

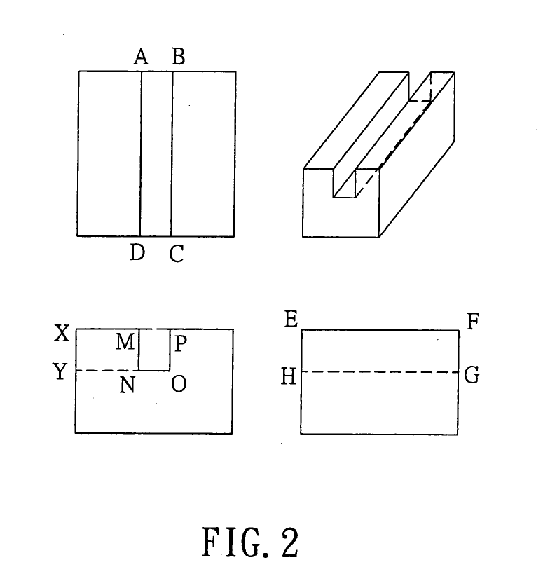

FIG. 3 shows volume enclosure relations;

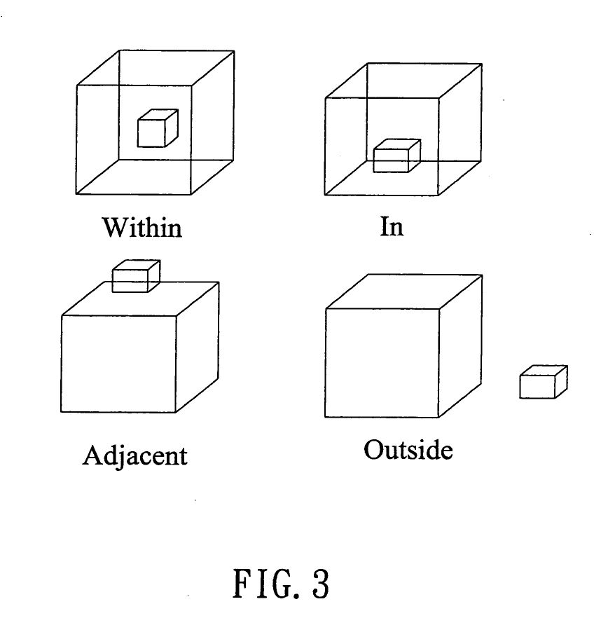

FIG. 4 shows overlapping faces of cuboids;

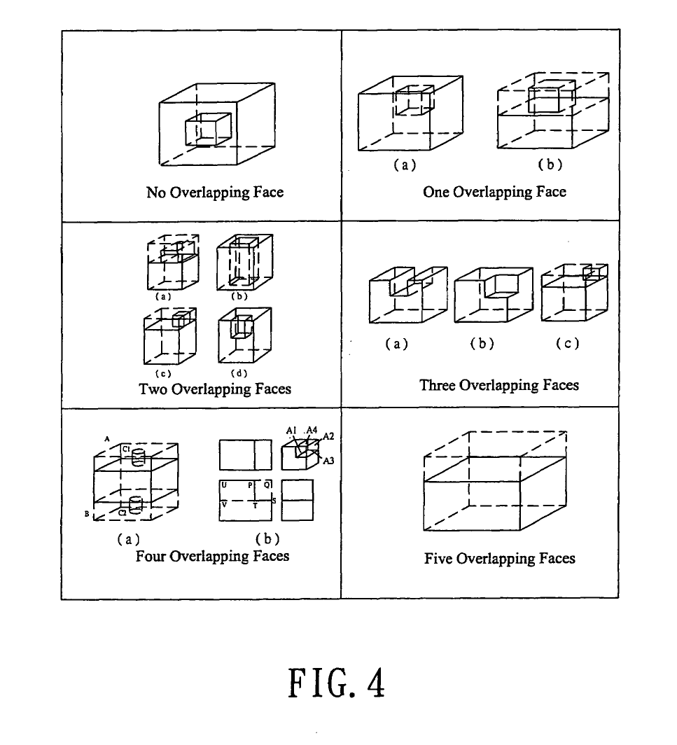

FIG. 5 shows the detailed process for recognizing features according to the present invention;

FIG. 6 shows the relational database of structural features;

FIG. 7 shows an interface for automatically retrieving feature names from a feature tree;

FIG. 8 shows an interface of a conversion program; and

FIG. 9 shows the structural features.

### DETAILED DESCRIPTION OF THE PREFERRED EMBODIMENTS

To clearly describe the method of the present invention and achieved effects, preferred embodiments are exemplified with drawings.

The method for recognizing features of a 3D solid model of the present invention is primarily to improve the traditional constructive solid geometry-based methods.

In general, the TCSG methods utilize form features for recognition, which are complicate and have bottlenecks on closed loop, uniqueness, overlapping face, volume enclosure, interactive features and fillet problems. Therefore, the present invention utilizes geometric and topological data of the feature tree for the CSG structure without graph-based recognition.

In the present invention, the feature tuples and their hierarchical taxonomies are forwardly derived from a feature tree of the solid model. Referring to feature tuples, the information of each feature tuples are retrieved from a feature tree of a CSG solid model, decomposed into geometric data and topological data, and stored into a relational database of structural features.

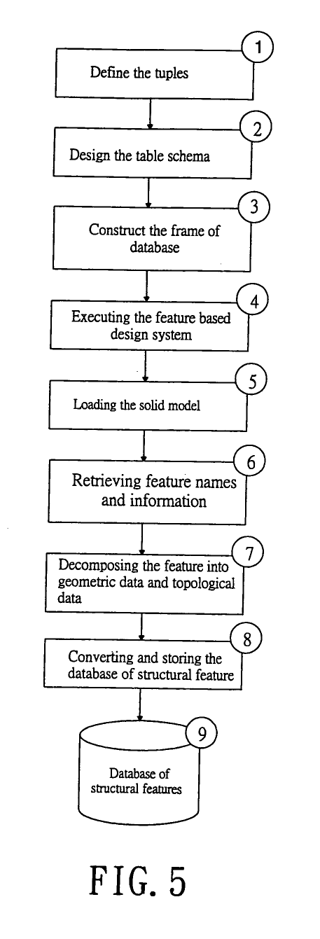

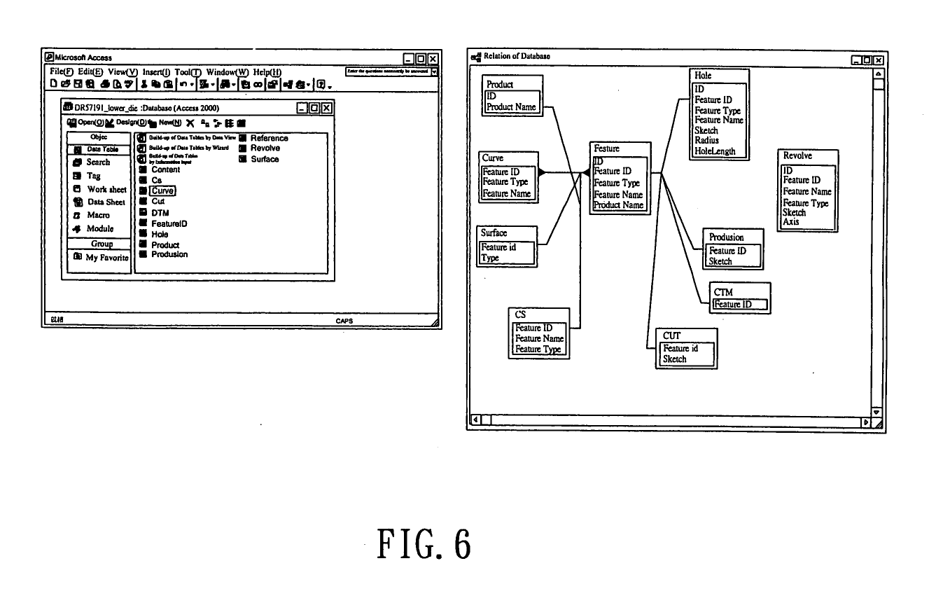

FIG. 5 shows the detailed process for recognizing features according to the present invention. First, the tuples are defined according to the feature tree of the solid model. Based on these tuples, a table schema for storing geometric data and topological data is designed in the relational form with hierarchical taxonomies and constructs as a frame of the database for structural features, as shown in steps 1˜3 of FIG. 5. FIG. 6 shows the relational database of structural features.

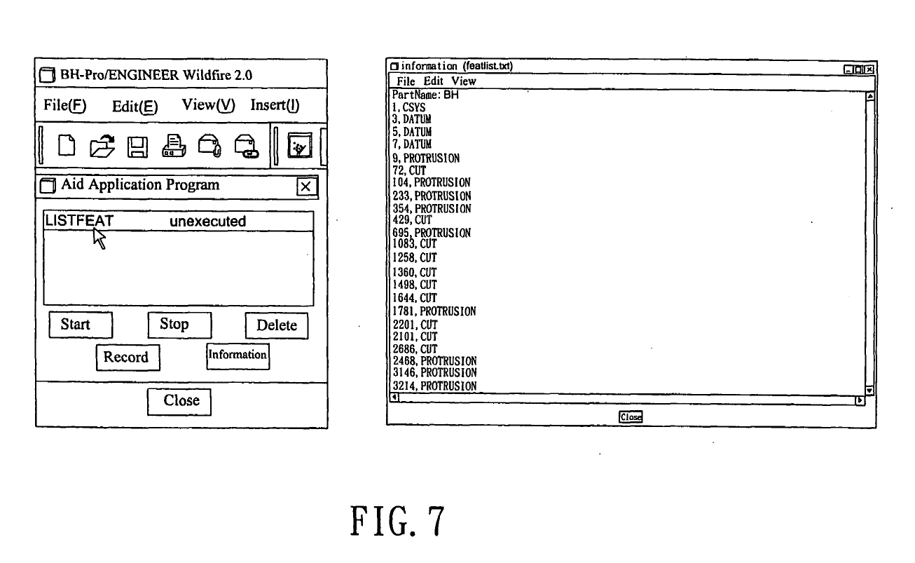

When a feature-based design system is executed and a solid model structure is loaded into the system, the feature names and information of the feature tree (such as geometric data and topological data) are retrieved by means of a program designed with plug-ins tool of the design system. According to the designed table schema, the retrieved feature names and information are analyzed and decomposed into geometric data and topological data, as shown in steps 4˜7 of FIG. 5. FIG. 7 shows an interface for automatically retrieving feature names from a feature tree.

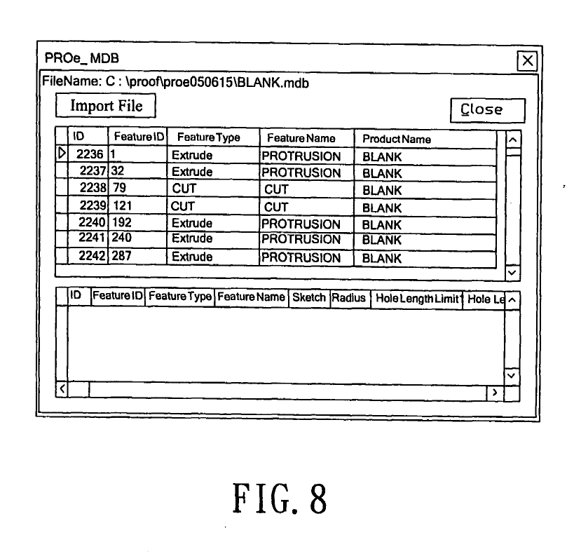

At last, the decomposed data are converted and stored in the database of structural features with a conversion program written based on the database of structural features, as shown in steps 8˜9 of FIG. 5 and FIG. 8 which shows an interface of a conversion program.

Computer drafting is primarily achieved based on geometric primitives. Therefore, geometric data and topological data are required for drawing a 3D object. Basic primitives for design such as form features, sizes and positions, can be organized from these data. For all drawing systems, points, lines, faces, angles, lengths and orientations are basic primitives for designing a geometric object. That is, any designed object can be decomposed into basic geometric primitives, such as points, lines, curves, circles, etc. These basic geometric primitives can further derive unlimited geometric features.

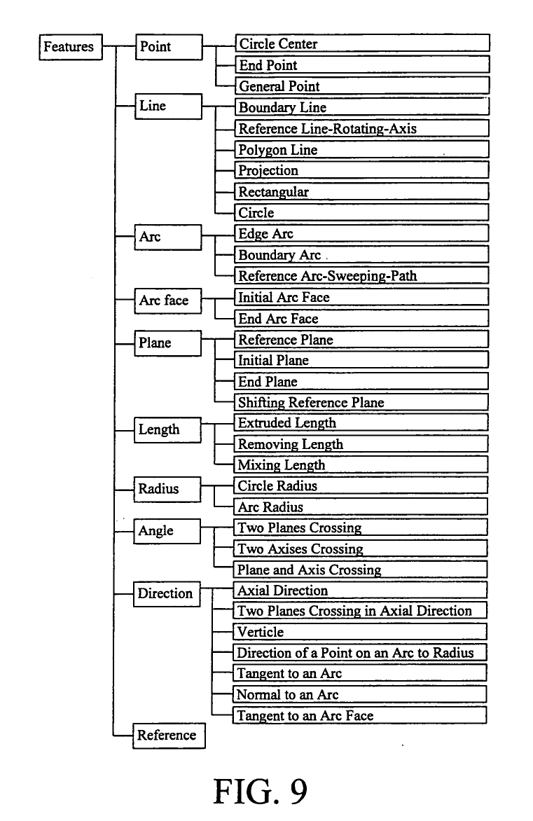

FIG. 9 shows the structure tree used in a preferred embodiment of the present invention, which is established reference to the basic geometric primitives of the feature-based design system.

Conventionally, the non-feature-based design system applies the B-Rep method and CSG method for recognition. However, these methods have a demerit of ambiguity (non-uniqueness). For example, in the B-Rep solid model, the overlapping and discrete faces of two objects may be viewed as the same face for lack of topological connection. The CSG solid model also leads problems such as closed loop, uniqueness, overlapped faces, volume enclosure, interactive feature and fillet, and therefore can not effectively recognize an object. All the above demerits in recognition result from form features.

On the other hand, recognition of the present invention utilizes the feature tree of the CSG, without graph-based recognition. That is, the geometric data and topological data created from the decomposed feature tree are used for recognition and thus resolve problems lead from graph-based recognition. In addition, the hierarchical taxonomies for building the relational database facilitates feature recognition with high speed and accuracy.

While the present invention has been described with the preferred embodiments, any modifications according to the embodiments are belonged to the present invention.

What is claimed is:

1. A method for recognizing features of a 3D solid model, comprising steps of:
defining an feature according to a decomposed feature tree and designing a database table schema for storing geometric data and topological data according to the feature, wherein the database is constructed in the form of a relational database of structural features;
executing a feature-based design software and loading a solid model into the system and automatically retrieving feature names and information of the feature tree so as to decompose the feature names and information into geometric data and topological data according to the table schema; and
storing the decomposed data from the system into and in the form of the database of structural features by means of a conversion program.

2. The method of claim 1, wherein the procedures for retrieving the feature names and information of the feature tree and decomposing them as the geometric data and the topological data are achieved by means of a plug-Ins tool in the system.
